(19) United States
(12) Patent Application Publication
(10) Pub. No.: US 2008/0106779 A1
(43) Pub. Date: May 8, 2008

(54) Laser Despeckle Device

(75) Inventors: Mark David Peterson, Lake Oswego, OR (US); David Elliott Slobodin, Lake Oswego, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: INFOCUS CORPORATION, Wilsonville, OR (US)

(21) Appl. No.: 11/932,817

(22) Filed: Oct. 31, 2007

Related U.S. Application Data
(60) Provisional application No. 60/864,123, filed on Nov. 2, 2006.

(51) Int. Cl. G02F 1/01

(52) U.S. Cl. 359/259; 359/237

(57) ABSTRACT

A projection system including at least a laser light source, an image generator, a projection lens assembly, and a despeckling device. The image image generator modulates laser light from the laser light source to form a projection image. The projection lens assembly is positioned downstream of the image generator and projects the projection image. The despeckling device limits laser speckle of the projected projection image.

### BACKGROUND AND SUMMARY

This application claims priority to U.S. Provisional Patent Application No. 60/864,123, filed Nov. 2, 2006, the entire contents of which are hereby incorporated herein by reference for all purposes.

### BACKGROUND AND SUMMARY

A laser is an optical source that emits a coherent beam of monochromatic light. Lasers can be configured to emit relatively high intensity light, and the light can be emitted in a relatively narrow beam. These characteristics make lasers well suited for many applications, including for use as a video projection light source.

The coherent nature of laser light can cause a phenomenon that is referred to as laser speckle—a field-intensity pattern produced by the mutual interference that can result when a laser beam experiences temporal and/or spatial fluctuations. For example, a coherent laser beam that shines on a non-specular reflecting surface may be at least partially scattered by the surface, especially if variations in the surface are greater than the wavelength of laser light. Coherent light scattered by different elements of the surface can interfere to form a speckle pattern. A speckle pattern is characterized by some areas of the laser light appearing blacked out, with the blacked out pattern appearing to sparkle when there is any relative movement between the surface and the observer.

The inventor herein has recognized that laser speckle may be undesirable for some applications, including video projection. Accordingly, a video projection system including a laser light source and a laser despeckler is disclosed.

### BRIEF DESCRIPTION OF THE DRAWINGS

FIG. 1 schematically shows an exemplary embodiment of a laser display system with a despeckling device.

FIG. 2 schematically shows an exemplary embodiment of a despeckling device.

### WRITTEN DESCRIPTION

A despeckling device can be used to limit the appearance of speckle patterns to an observer. As described below, a despeckling device can rapidly change the speckle pattern. In some embodiments, the speckle pattern can be changed so rapidly that the integration time of the human eye is incapable of detecting the movement in the speckle patterns. In this way, even though a speckle pattern may always be present, the speckle pattern changes at a high enough frequency so that it is less perceptible. Furthermore, the speckle pattern can be changed with a sufficient number of permutations so that the same speckle pattern does not repeat too quickly or too often and thus become more perceptible. In some embodiments, the speckle patterns on the viewing screen may overlap, thereby reducing speckle contrast.

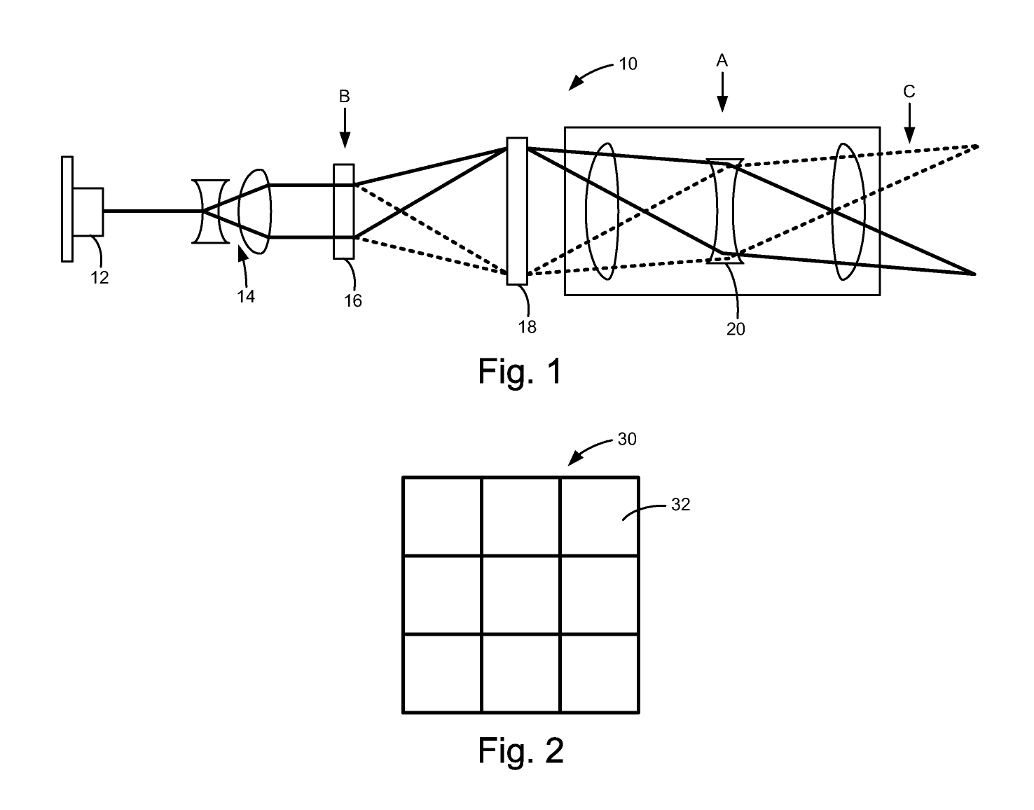

FIG. 1 schematically shows an exemplary embodiment of a laser display system 10 with a despeckling device. The display system may include a light source 12. In some embodiments, light source 12 may be a coherent light source such as a laser. Light source 12 emits a laser beam of a desired wavelength in either a continuous or pulsed fashion. The laser beam may be expanded by a beam expander 14 to produce a collimated beam with the necessary diameter for beam-shaping optics 16. In one embodiment, beam-shaping optics 16 may include an integrator that provides efficient, uniform illumination over the area of an image generating device 18. In some embodiments, image generating device 18 may include an LCD or DLP. In some embodiments, image generating device 18 may include a spatial light modulator. The image generated from the image generating device 18 may pass through a projection lens 20 before it reaches a viewing surface, such as a display screen.

The location of the despeckling device in display device 10 can be selected to help limit the perceptibility of the speckle pattern. It is believed that a despeckling device that is located after an image generating device (e.g., LCD, DLP, etc.) can be more effective than a despeckling device that is located in the illumination path before an image generating device, although such positioning is not necessarily required in all embodiments. In one embodiment, the despeckling device may be positioned at a lens stop A, as shown in FIG. 1. In another embodiment, the despeckling device may be positioned at an illumination stop B, as shown in FIG. 1. In still another embodiment, the despeckling device may be positioned downstream of the projection lens assembly.

In some embodiments, a despeckling device can be positioned in the illumination path before the image generating device. Such an arrangement can help limit image fuzziness when certain types of despeckling devices are used, such as moving diffusers.

Some despeckling devices may be configured to change the phase and/or polarity of the laser light. As nonlimiting examples, a despeckling device may include a variable phase plate or a variable polarization rotator. Such a variable polarization rotator may include an LCD with no polarizers.

As schematically shown in FIG. 2, a variable polarization rotator 30 may include multiple cells. Each cell 32 may represent one phase adjustable region. For example, in the depicted embodiment, the despeckling device can includes a 3×3 matrix of nine cells. In some embodiments, one cell may be rotated independent of its neighboring cells. The cells may be rotated in various manners to create numerous interference patterns or speckles on the viewing surface. In one example, the cells may be adjusted to move or rotate randomly. In another example, the cells may be adjusted to move or rotate in a predetermined sequence or pattern.

The despeckling device described above may decrease the perceptibility of laser speckle to a viewer. For example, since the phase of light traveling through each cell can be altered by rotating the cell, numerous speckle patterns may be generated by rotating the cells in different combinations. For example, a despeckling device with m cells may produce n^{m} combinations, where n equals the phase variations possible for each cell individually, and m equals the total number of cells. As a nonlimiting example, if each cell is configured to produce two different phases, and there is a 3×3 matrix of nine cells, then there are 2⁹=512 combinations. If each cell is configured to produce four different phases and there are nine cells, then there are 4⁹=262,144 combinations. The above are not meant to be limiting, but rather are provided as examples of the large number of variations that are possible even if only nine cells are used. Using more cells exponentially increases the number of possible combinations.

As the states of the various cells are changed, the speckle patterns on the viewing screen also change. If the cells are changed sufficiently fast, the speckle patterns can change rapidly enough to be substantially unperceivable to an observer. In some embodiments, the speckle patterns on the viewing screen may overlap, thereby reducing speckle contrast. Accordingly, a despeckling device may reduce speckle through a reduction of coherence, and/or spatial and/or temporal phase randomization of a laser beam.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A projection system, comprising:
a laser light source;
an image generator to modulate laser light from the laser light source to form a projection image;
a projection lens assembly downstream of the image generator to project the projection image; and
a despeckling device operably positioned intermediate the laser light source and the image generator, the despeckling device being configured to limit laser speckle of the projected projection image.

2. The projection system of claim 1, where the despeckling device includes a matrix of cells individually controllable to change a phase of light from the laser light source.

3. The projection system of claim 2, where the image generator includes an LCD image generator.

4. The projection system of claim 2, where the image generator includes a DLP image generator.

5. The projection system of claim 2, where the despeckling device includes at least one variable phase plate.

6. The projection system of claim 1, where the despeckling device includes a matrix of cells individually controllable to change a polarity of light from the laser light source.

7. The projection system of claim 6, where the image generator includes an LCD image generator.

8. The projection system of claim 6, where the image generator includes a DLP image generator.

9. The projection system of claim 6, where the despeckling device includes at least one variable polarization rotator.

10. A projection system, comprising:
a laser light source;
an image generator to modulate laser light from the laser light source to form a projection image;
a projection lens assembly downstream of the image generator to project the projection image; and
a despeckling device operably positioned downstream of the image generator, the despeckling device being configured to limit laser speckle of the projected projection image.

11. The projection system of claim 10, where the despeckling device includes a matrix of cells individually controllable to change a phase of light from the laser light source.

12. The projection system of claim 11, where the image generator includes an LCD image generator.

13. The projection system of claim 11, where the image generator includes a DLP image generator.

14. The projection system of claim 11, where the despeckling device includes at least one variable phase plate.

15. The projection system of claim 10, where the despeckling device includes a matrix of cells individually controllable to change a polarity of light from the laser light source.

16. The projection system of claim 15, where the image generator includes an LCD image generator.

17. The projection system of claim 15, where the image generator includes a DLP image generator.

18. The projection system of claim 15, where the despeckling device includes at least one variable polarization rotator.

19. The projection system of claim 10, where the despeckling device is operably positioned intermediate the image generator and the projection lens assembly.

20. The projection system of claim 10, where the despeckling device is operably positioned downstream of the projection lens assembly.
